(19) United States
(12) Patent Application Publication
(10) Pub. No.: US 2003/0069947 A1
(43) Pub. Date: Apr. 10, 2003

(54) System and methods for network detection and configuration

(76) Inventor: Gregory J. Lipinski, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/972,350

(22) Filed: Oct. 5, 2001

(51) Int. Cl. G06F 15/177

(52) U.S. Cl. 709/220

(57) ABSTRACT

In an embodiment, the present invention is directed to a system and methods for configuration of a network-capable device, wherein the methods are implemented in programmable logic on the network-capable device. One method may comprise the steps of: saving existing network configuration settings for at least one network interface of the network-capable device; receiving network configuration parameters from at least one configuration server; testing the at least one network interface utilizing received network configuration parameters; and restoring the existing saved network configuration settings, if the step of testing determines that the received network configuration parameters are incorrect.

### FIELD OF THE INVENTION

The present invention is, in general, related to communication network detection and configuration and more particularly to a system and methods for network configuration after automatic network detection.

### BACKGROUND OF THE INVENTION

When attempting to connect a device to a network such as the Internet, it is frequently necessary to configure the device for communication over the respective network. Configuration allows data packets from the network to be routed to the device. Moreover, configuration prevents the device from interfering with other devices on the network.

Configuration typically involves manually setting all of the various network settings to specific values. For example, it may be required to set the Internet Protocol (IP) address of the device. The subnet mask may be set. Additionally, it may be necessary to select pertinent software protocols such as TCP/IP (Transmission Control Protocol/Internet Protocol). Other configuration settings may allow others to access resources associated with the device (e.g., a storage peripheral). The IP address of a domain name server (DNS) may be set. Clearly, this process is complex and, therefore, quite challenging even for computer users of moderate experience.

To assist inexperienced users, a set-up “wizard” presents various fields to a user via a graphical user interface (GUI) to obtain the various configuration values. After receiving the values, the wizard sets the network settings to the received values. An example of a set-up wizard for personal computers (PCs) may be located on WINDOWS™ operating systems via the NETWORK icon of the control panel. However, the user is required to know the correct values for the various settings. If the user enters an incorrect value, the device may not be able to communicate and the device may disrupt the communications of other devices on the network.

Alternatively, the process may be automated. Dynamic Host Configuration Protocol (DHCP) is a protocol that simplifies connection to a communication network such as the Internet. DHCP is an open protocol which is defined by the Dynamic Host Configuration Standard working group (DHC WG) of the Internet Engineering Task Force (ITF). The working group has published various documents pursuant to this protocol. Details of the protocol may be obtained from the request for comments (RFC) 1541 document that is available via various Internet draft repositories.

DHCP permits dynamic assignment of IP addresses to devices on a network. Dynamic assignment simplifies configuration of a device for network communication by removing the necessity of having an individual assign an IP address to a device. Instead, the assignment occurs by communication between the device that requires an IP address and a DHCP server. The device to be networked broadcasts a DHCPDISCOVER packet over a particular communication medium (e.g., an Ethernet). In response, the DHCP server returns a DHCPOFFER packet. The DHCPOFFER packet includes an IP address that the device may utilize and an amount of time that the device may utilize the IP address (the lease). The device may accept the IP address and the lease by returning a DHCPREQUEST packet. The protocol is completed when the DHCP server returns a DHCPACK packet.

In addition to dynamically assigning IP addresses, the DHCP protocol may provide other configuration parameters to a device to be networked. For example, the DHCP protocol may provide the subnet mask, default router, Domain Name System (DNS) server, and/or the like.

Although the DHCP protocol typically requires initialization or selection by a user, it is the goal of the DHCP protocol to allow devices to be automatically networked by providing the various configuration parameters without requiring manual intervention. However, most inexperienced users do not recognize that DHCP allows automatic configuration. Moreover, the users must explicitly specify a specific network interface on which the DHCP protocol will be performed as well as specify the DHCP configuration. Accordingly, the users may require assistance from technical personnel (e.g., a help desk) before the users are able to invoke the DHCP protocol.

It shall be also appreciated that actual implementations of the DHCP protocol do not always follow the exact protocol. In general, this may be the result of an unintentional error in programming by the developer of the DHCP server. Moreover, the DHCP server may provide erroneous information. In either case, the DHCP server may, in practical circumstances, be unable to fulfill its intended purpose. When the DHCP fails for any reason, a user is required to revert to the manual configuration steps.

### BRIEF SUMMARY OF THE INVENTION

In an embodiment, the present invention is directed to a system and methods for configuration of a network-capable device, wherein the methods are implemented in programmable logic on the network-capable device. One method may comprise the steps of: saving existing network configuration settings for at least one network interface of the network-capable device; receiving network configuration parameters from at least one configuration server; testing the at least one network interface utilizing received network configuration parameters; and restoring the existing saved network configuration settings, if the step of testing determines that the received network configuration parameters are incorrect.

### BRIEF DESCRIPTION OF THE DRAWINGS

FIG. 1 is an exemplary Internet appliance that may implement embodiments of the present invention.

FIG. 2 is an exemplary flowchart of steps according to embodiments of the present invention.

### DETAILED DESCRIPTION OF THE INVENTION

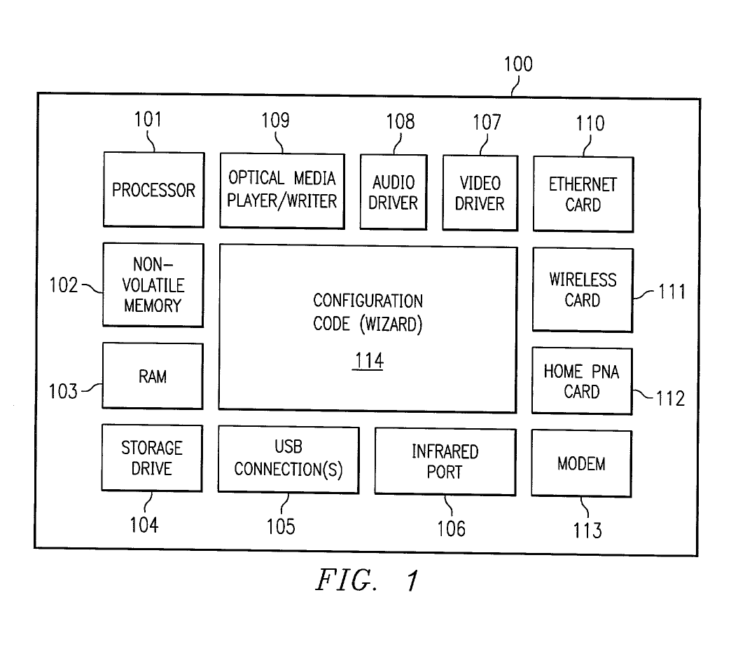

The present invention is directed toward a system and methods for facilitating network connection of a network-capable device to a communication network. In embodiments of the present invention, the network-capable device to be connected is referred to herein as an “Internet appliance.” FIG. 1 depicts exemplary Internet appliance 100 which may implement embodiments of the present invention.

Internet appliance 100 comprises processor 101 to execute code that defines the functionality of Internet appliance 100. Processor 101 may be any general purpose processor. Suitable processors, without limitation, include processors from the ITANIUM family of processors and RISC processors. However, the present invention is not restricted by the architecture of processor 101 as long as processor 101 supports the inventive operations as described herein. Internet appliance 100 also includes random access memory (RAM) 103, which may be SRAM, DRAM, SDRAM, or the like. Internet appliance 100 includes non-volatile memory 102 which may be PROM, EPROM, EEPROM, or the like. RAM 103 and ROM 102 may hold user and system data and programs as is well known in the art.

Internet appliance 100 further comprises storage drive 104 which may be a hard drive, for example. Internet appliance 100 may comprise various drivers to provide user output. For example, internet appliance 100 may comprise audio driver 108 to drive an external set of speakers. Internet appliance 100 may comprise video driver 107 to drive a monitor or television. Video driver 107 may provide information to a user as a user interface. Additionally, video driver 107 may be utilized to provide video via multi-media content to a user. Internet appliance 100 may comprise I/O ports such as USB connection(s) 105 to communicate with peripherals and/or infrared port 106 to interact with a user via a remote control device.

Internet appliance 100 may further comprise an optical media player/writer 109. Internet appliance 100 may control media player/writer 109 to retrieve MP3 files (compressed audio files pursuant to the Moving Picture Experts Group (MPEG), audio layer 3 protocol) from an optical media to produce audio signals for presentation to a user via audio driver 108. Additionally, Internet appliance 100 may control media player/writer 109 to generate video information (e.g., a movie) for presentation to a user via video driver 107.

Internet appliance 100 comprises a number of network interfaces to allow its use in any number of communication environments. For example, Internet appliance 100 may further comprise modem 113 that may allow Internet appliance 100 to communicate with a dialup Internet service provider (ISP) as is well known in the art.

Internet appliance 100 may comprise Ethernet card 110. Ethernet is a local-area network (LAN) protocol. Ethernet uses a bus or star topology and supports data transfer rates of 10 Mbps (higher data transfer rates are obtainable by using updated versions of the protocol). The Ethernet specification is the basis for the IEEE 802.3 standard, which specifies the physical and lower software layers of the networking protocol. Additionally, Ethernet uses the carrier sense multiple-access/collision detection (CSMA/CD) access method to handle simultaneous demands from multiple network devices. Ethernet is one of the most widely implemented LAN standards.

Internet appliance 100 may comprise wireless card 111. Wireless card 111 may enable Internet appliance 100 to communicate over a wireless communication network via a suitable wireless protocol such as IEEE 802.11b. Specifically, IEEE 802.11b defines a protocol for a wireless LAN. IEEE 802.11b defines physical layer requirements (modulation scheme, frequency/wavelength requirements, data rates, power limitation requirements, and the like) for the wireless communication. For example, Internet appliance 100 may transmit data utilizing direct sequence spread-spectrum communication. Alternatively, Internet appliance 100 may utilize frequency-hopping communication. Moreover, IEEE 802.11b defines the medium access scheme. The medium access scheme defines when a device may communicate over the wireless link to avoid contention between different devices.

Internet appliance 100 may also comprise HOMEPNA card 112. HOMEPNA is a broadband home networking standard developed by the Home Phoneline Networking Alliance. This technology allows all the components of a home network to interact over the home's existing telephone wiring without disturbing the existing voice or fax services. In the same way a LAN operates, home networking processes, manages, transports and stores information, which enables the disparate devices in a home network (e.g., Internet appliances, telephones, fax machines, desktops, laptops, printers, and/or the like) to connect and integrate over a home's unpredictable wiring topology.

It shall be appreciated that a router or bridge to the Internet may also be associated with the LAN network associated with Ethernet card 110, the wireless network associated with wireless card 111, or the phone-line network associated with HOMEPNA card 112. By providing access to the Internet, Internet appliance 100 is capable of implementing a robust number of applications. Internet appliance 100 may download audio information (e.g., music content) from Internet radio stations. Internet appliance 100 may download video information (e.g., MPEG files) from various websites. Additionally, Internet appliance 100 may receive streaming video from various sources for presentation to a user.

By providing multiple network interfaces, Internet appliance 100 may be utilized in any number of settings. However, by providing the capability to connect to various networks, configuration of Internet appliance 100 to communicate via a network of the networks is necessary. However, as previously noted, configuration of a network device to communicate over one network, yet alone multiple networks, may be quite challenging for most users. Accordingly, Internet appliance 100 comprises configuration code 114. Configuration code 114 preferably defines a “wizard” graphical user interface that automatically detects network connectivity, downloads configuration data from a configuration server (e.g., DHCP server), and enables a user to modify configuration data (if desired) among other tasks.

The embodiments of the present invention greatly simplify the network connectivity of Internet appliance 100. When broadband networking, home networking, and/or the like is selected for configuration, embodiments of the present invention automatically scan all network interfaces and attempt to connect to a configuration server (e.g., DHCP) on each network. If a successful connection is achieved, embodiments of the present invention preferably set all of the applicable network properties and report the results to the user. The user can simply accept the automated set up parameters, or can choose to modify one or more of them. If the user chooses to modify any of the set up parameters, embodiments lead the user through the changes. Once the step up parameters are set, embodiments of the present invention perform the final network connection tests.

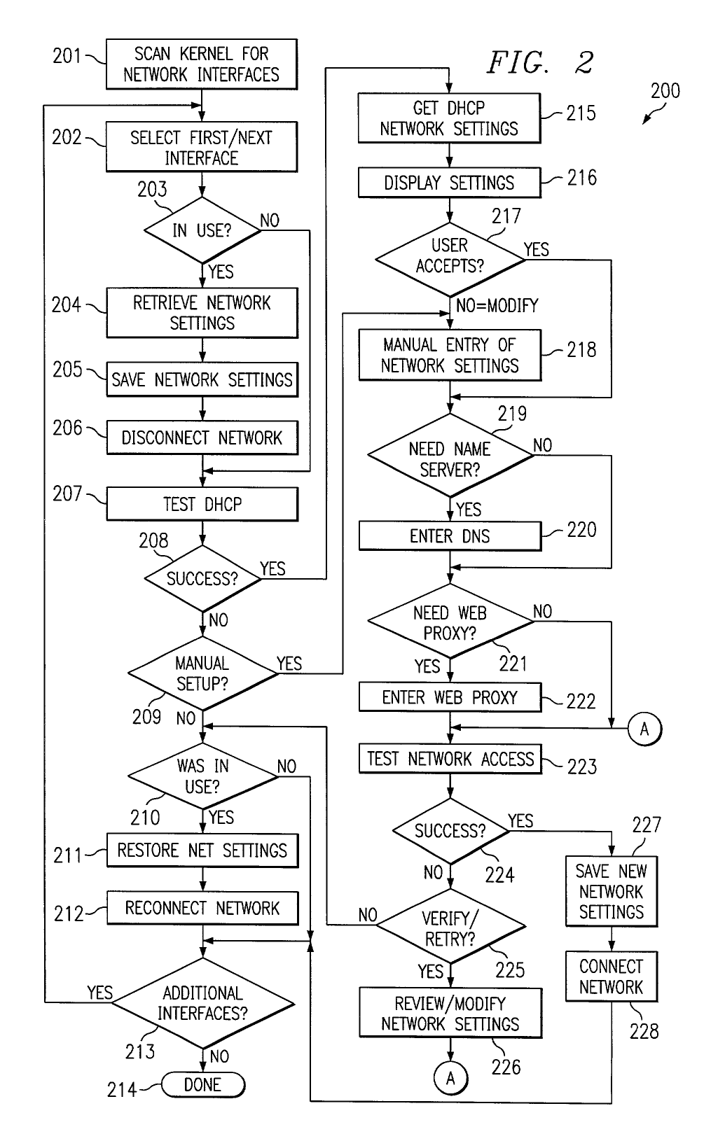

FIG. 2 depicts exemplary flowchart 200 that may be implemented by configuration code 114 in accordance with embodiments of the present invention. It shall be appreciated that the present invention is not limited to Internet appliance 100. Embodiments of the present invention may be implemented by any suitable processor-based networking-capable device including, but not limited to, desktop computers, laptop computers, personal data assistants (PDAs), video game consoles, computer peripherals, and/or the like.

In step 201, configuration code 114 scans the kernel of the operating system for network interfaces. For example, configuration code 114 may perform a system call or system calls to determine that Internet appliance 100 comprises an Ethernet interface, a wireless interface, a phone-line network interface, and/or the like.

In step 202, the first or next interface is selected depending on whether step 202 is encountered as the first iteration of the process flow. Specifically, embodiments of the present invention are preferably operable to analyze each network interface of Internet appliance 100. For example, configuration code 114 may iteratively analyze an Ethernet interface, a HOMEPNA interface, an IEEE 802.11b interface, a dial-up interface, and/or the like according to the process flow of flowchart 200. Configuration code 114 will preferably attempt to configure each network interface that is identified by the kernel according to the process flow described below.

In step 203, a logical comparison is made to determine if the network interface selected in step 202 is in use. If the network interface is not in use, the process flow proceeds to step 207. If the network is in use, the current network settings are retrieved (step 204) and the settings are saved (step 205) and configuration code 114 disconnects Internet appliance 100 from the network (step 206).

In step 207, a test is made to initiate communications with the DHCP server associated with the network. A logical comparison is made to determine whether the DHCP server test was successful (step 208). If successful, the process flow proceeds to step 215. If the test was not successful, the process flow proceeds to step 209. In step 209, the user may be queried to determine whether the user wishes to perform manual configuration. If so, the process flow proceeds to step 218. If not, the process flow proceeds to step 210.

If the DHCP test was successful, configuration code 114 may obtain DHCP network settings (step 215). For example, configuration code 114 may broadcast a DHCPDISCOVER packet using the selected network interface. In response, the DHCP server returns a DHCPOFFER packet. The DHCPOFFER packet includes an IP address that the device may utilize and an amount of time that the device may utilize the IP address (the lease). The IP address and the lease may be accepted by returning a DHCPREQUEST packet. The protocol is completed when the DHCP server returns a DHCPACK packet.

In step 216, the received network settings are presented to the user. The user may choose to accept the received settings (step 217). If the user accepts the settings, the process flow proceeds to step 219. If the user does not accept the settings, the process flow proceeds to step 218. It shall be appreciated that embodiments of the present invention may provide several advantages by interfacing with a user in this manner. Specifically, a novice user is not required to explicitly select an interface and perform lengthy parameter modification steps. The user may simply choose to accept to the received settings. However, a more advanced user may also configure the device according to the user's specific needs.

In step 218, the user may manually modify received parameters and/or manually enter parameters for the selected network interface. The parameters are preferably presented in a “wizard” type graphical user interface. Specifically, each individual parameter may be presented via an individual screen. The user may be given the opportunity to edit each parameter. The user may also navigate between the individual screens of the wizard. By presenting the parameters in a “wizard” format, the user interface minimizes the amount of technical knowledge required by the user.

In step 219, a logical comparison is made to determine whether a domain name server (DNS) is needed. Specifically, some DHCP servers have been implemented that do not identify a DNS. Accordingly, if an identification of the DNS is not received in the received parameters, the process flow proceeds to step 220. The name of the DNS is entered via a user interface (step 220). If a DNS is identified in the received parameters, the process flow proceeds to step 221.

In step 221, a logical comparison is made to determine whether a web proxy server is needed. If a web proxy is not needed, the process flow process to step 223. If a web proxy server is needed, the web proxy server identifier or name is entered in step 222. A web proxy server is known in the art as a transparent, trusted media between web clients and web servers. A web proxy server receives HTTP REQUESTs and attempts to satisfy the REQUESTs according to the HTTP protocol. A web proxy server may first attempt to satisfy a REQUEST by retrieving the requested object from its cache and sending the object to the browser in an HTTP RESPONSE message. If the web proxy server does not find the object in its cache, it forwards the HTTP REQUEST to an ordinary web server, receives HTTP RESPONSE from the server, and forwards the response back to the client. Depending on headers in the HTTP RESPONSE, the web proxy server also caches the object associated with the message. Web proxy servers are advantageous for two primary reasons. First, web proxy servers increase the perceived performance of HTTP transactions by caching web objects. Secondly, web proxy servers may implement firewall security by only allowing requests to be forwarded through a firewall gateway.

In step 223, network access is tested. The network access may be tested by sending HTTP requests to a plurality of predefined web servers. If an HTTP response is received from any of the predefined web servers, the network interface is functioning properly. Also, it is not required to send HTTP requests to a plurality of web servers. However, it is preferred because a single web server may be malfunctioning at the time of the network test. A failure of a single web server should preferably not impact the analysis of the network test. Additionally or alternatively, the configuration settings may be tested according to network testing techniques that are known in the art.

In step 224, a logical comparison is made upon the basis of the network test. If the network access was successful, the process flow proceeds to step 227. In step 227, the network settings are saved and configuration code connects Internet appliance 100 to the network (step 228). The process flow proceeds from step 228 to step 213.

If network access was not successful, the process flow proceeds to step 225. In step 225, the user is presented with the opportunity to retry configuration of the network interface. If the user does not desire to retry configuration, the process flow proceeds to step 210. If the user desires to retry configuration of the user interface, the process flow proceeds to step 226. In step 226, the user is provided the opportunity to review and/or modify the network settings. The settings are preferably presented in a wizard format. Additionally, any settings, that are determined to be incorrect and/or inoperable, are identified to the user for modification. After modification (if any), the process flow proceeds to step 223 to retest the network settings.

After proceeding from step 209 (i.e., manual setup was rejected) or from step 225 (i.e., the user did not wish to retry configuration), a logical comparison is made to determine if the selected network interface was previously in use (step 210). If it was previously in use, the network settings stored in step 205 are restored (step 211). In step 212, configuration code 114 reconnects Internet appliance 100 to the selected network.

In step 213, a logical comparison is made to determine whether any additional interfaces are present. If so, the process flow proceeds to step 202 to perform another iteration of the process flow. If not, the process flow proceeds to step 214 to end its operations.

Embodiments of the present invention may be implemented utilizing software and/or any other suitable programmable logic (e.g., an application specific integrated circuit). Specifically, embodiments of the present invention may implement the preceding steps of flowchart 200 as code resident on a processor-based network device. The processor of the devices may be operable to execute the various steps defined by the code in conjunction with other software and hardware interfaces (e.g,. a networking card or cards).

Moreover, embodiments of the present invention may provide any number of advantages. Embodiments of the present invention allow users of limited experience to quickly network processor-based devices. Inexperienced users are not required to understand the difference between different network interfaces. Specifically, an inexperienced user is not required to learn the differences between an Ethernet network, HOMEPNA network, a wireless network, and/or the like. Moreover, embodiments of the present invention do not restrict more experienced users from modifying the configuration parameters received from a DHCP server. Additionally, failure of the configuration parameters received from a DHCP server does not render the device inoperable. Specifically, the prior network settings may be restored thereby preventing erroneous data from causing an operable network interface to become inoperable.

1. A method for configuration of a network-capable device, wherein said method is implemented in programmable logic on said network-capable device, comprising:
saving existing network configuration settings for at least one network interface of said network-capable device;
receiving network configuration parameters from at least one configuration server;
testing said at least one network interface utilizing received network configuration parameters; and
restoring said existing saved network configuration settings, if said step of testing determines that said received network configuration parameters are incorrect.

2. The method of claim 1 further comprising:
detecting each network interface of said network-capable device.

3. The method of claim 1 further comprising:
attempting to communicate with a configuration server for each network interface of said device.

4. The method of claim 1 further comprising:
configuring said network-capable device by setting network settings for said at least one network interface to said received network configuration parameters.

5. The method of claim 1 further comprising:
receiving user input to modify received configuration parameters.

6. The method of claim 5 wherein said step of receiving user input to modify received configuration parameters presents said received configuration parameters to a user via a graphical user interface.

7. The method of claim 5 further comprising:
configuring said network-capable device by setting network settings for said at least one network interface to configuration parameters modified by a user.

8. The method of claim 1 wherein said at least one network interface is an Ethernet interface, a phone-line interface, or a wireless interface.

9. The method of claim 1 wherein said at least one configuration server is a Dynamic Host Configuration Protocol (DHCP) server.

10. The method of claim 1 further comprising:
receiving user input to accept received configuration parameters for use with said at least one network interface.

11. A computer readable medium comprising processor executable instructions for configuration of a network-capable device, said computer readable medium comprising:
code for saving existing network configuration settings for at least one network interface of said network-capable device;
code for receiving network configuration parameters from at least one configuration server;
code for testing said at least one network interface utilizing received network configuration parameters; and
code for restoring said saved existing network configuration settings, if said step of testing determines that said received network configuration parameters are incorrect.

12. The computer readable medium of claim 11 further comprising:
code for detecting each network interface of said network-capable device.

13. The computer readable medium of claim 11 further comprising:
code for attempting to communicate with a configuration server for each network-interface of said network-capable device.

14. The computer readable medium of claim 11 further comprising:
code for configuring said network-capable device by setting network settings of said at least one interface to said received network configuration parameters.

15. The computer readable medium of claim 11 further comprising:
code for receiving user input to modify received configuration parameters.

16. The computer readable medium of claim 15 wherein said code for receiving user input to modify received configuration parameters presents said received configuration parameters to a user via a graphical user interface.

17. The computer readable medium of claim 15 further comprising:
code for configuring said network-capable device by setting network settings of said at least one interface to said configuration parameters modified by said user.

18. The computer readable medium of claim 11 wherein said at least one network interface is an Ethernet interface, a phone-line interface, or a wireless interface.

19. The computer readable medium of claim 11 wherein said at least one configuration server is a Dynamic Host Configuration Protocol (DHCP) server.

20. The computer readable medium of claim 11 further comprising:
code for receiving user input to accept received configuration parameters for use with said at least one network interface.

21. A method for configuration of a network-capable device, wherein said method is implemented in programmable logic on said network-capable device, comprising:
(a) saving current network settings associated with a network interface of said network-capable device;
(b) attempting to communicate with a configuration server of a network associated with said network interface to receive configuration parameters;
(c) providing a user interface to allow the user interface to modify received configuration parameters;
(d) testing said received configuration parameters on said network interface to determine whether said received configuration parameters are correct;
(e) if said configuration parameters are correct, setting network settings for use with said network interface to said received configuration parameters;
(f) if said configuration parameters are not correct, restoring said saved current network settings previously saved in step (a); and
(g) returning to step (a) if another network interface is present in said network-capable device that has not been previously analyzed according to steps (a) through (f).

22. The method of claim 21 wherein said configuration server is a Dynamic Host Configuration Protocol (DHCP) server.

23. The method of claim 21 wherein said network interface is an Ethernet interface, a phone-line interface, or a wireless interface.

24. The method of claim 21 wherein said step of providing a user interface presents configuration parameters to the user in a graphical user interface format.

25. A network-capable device, comprising:
a processor for executing code;
at least one network interface;
code for saving current network configuration settings for said at least one network interface of said network-capable device;
code for receiving network configuration parameters from at least one configuration server;
code for testing said at least one network interface utilizing received network configuration parameters; and
code for restoring said saved current network configuration settings, if said step of testing determines that said received network configuration parameters are incorrect.

26. The network-capable device of claim 25 further comprising:
code for detecting each network interface of network-capable device.

27. The network-capable device of claim 25 further comprising:
code for attempting to communicate with a configuration server for each network-interface of network-capable device.

28. The network-capable device of claim 25 further comprising:
code for configuring said network-capable device by setting network settings of said at least one interface to said received network configuration parameters.

29. The network-capable device of claim 25 further comprising:
code for receiving user input to modify received configuration parameters.

30. The network-capable device of claim 29 further comprising:
code for configuring said network-capable device by setting network settings of said at least one interface to said configuration parameters modified by said user.

31. The network-capable device of claim 25 wherein said at least one network interface is an Ethernet interface, a phone-line interface, or a wireless interface.

32. The network-capable device of claim 25 wherein said at least one configuration server is a Dynamic Host Configuration Protocol (DHCP) server.

33. The network-capable device of claim 25 further comprising:
code for receiving user input to accept received configuration parameters for use with said at least one network interface.
